(19) United States
(12) Patent Application Publication
(10) Pub. No.: US 2025/0087736 A1
(43) Pub. Date: Mar. 13, 2025

(54) SYSTEM AND METHOD OF CUTTING TABS IN A BATTERY CELL FOIL FOR A STACKED BATTERY CELL

(71) Applicant: GM Global Technology Operations LLC, Detroit, MI (US)

(72) Inventors: Hwanchul Kim, Dryden, MI (US); Mahboob Murshed, Commerce Township, MI (US)

(21) Appl. No.: 18/462,599

(22) Filed: Sep. 7, 2023

(51) Int. Cl. H01M 10/04; B23K 26/38; H01M 50/533

(52) U.S. Cl. CPC H01M 10/0404; B23K 26/38; H01M 50/533; B23K 2101/38

(57) ABSTRACT

A system for forming tabs in a battery cell foil includes a web roller including a surface and a guide element support member shiftably connected to the web roller. The guide element support member includes a guide element support surface. A plurality of guide elements is supported on the guide element support member. Each of the plurality of guide elements being associated with a different tab dimension. The plurality of guide elements being selectively shiftable relative to the surface of the web roller. A tab cutting mechanism directed at one of the plurality of guide elements. A control system is operatively connected to the guide element support member. The control system is operable to selectively shift select ones of the plurality of guide elements into alignment with the tab cutting mechanism in order to selectively control dimensional attributes of tabs being formed in a moving sheet of battery cell foil.

### INTRODUCTION

The subject disclosure relates to the art of battery manufacturing and, more particularly, to a system and method of cutting tabs in a battery cell foil for a stacked battery cell.

Battery cells are formed from stacked foils separated from one another by an insulator. A first portion of the stacked foils are connected to form a cathode of the battery cell and a second portion of the stacked foils are connected to form an anode of the battery cell. Typically, a laser cuts notches in the foils. The notches form tabs having a uniform length that become a connection point. A welding plate is moved across the tabs to fold them over prior to being welded.

The uniform length of the tabs, when folded, create overlapping surfaces. During the welding process, the overlapping surfaces do not create a robust joint. Changing the length of the tabs is not practical. The tabs are cut while the foil is moving, therefore changing tab length would require stopping the foil, changing laser settings, and restarting the foil. The time and effort required to change tab settings adds to production costs and increases production complexity. Accordingly, it is desirable to provide a system that would provide adjustable tab lengths without interrupting the manufacturing flow.

### SUMMARY

A system for forming tabs in a battery cell foil, in accordance with a non-limiting example, includes a web roller including a surface and a guide element support member shiftably connected to the web roller. The guide element support member includes a guide element support surface that is substantially co-planer with the surface of the web roller. A plurality of guide elements is supported on the guide element support member. Each of the plurality of guide elements being associated with a different tab dimension. The plurality of guide elements being selectively shiftable relative to the surface of the web roller. A tab cutting mechanism directed at one of the plurality of guide elements. A control system is operatively connected to the guide element support member. The control system is operable to selectively shift select ones of the plurality of guide elements into alignment with the tab cutting mechanism in order to selectively control dimensional attributes of tabs being formed in a moving sheet of battery cell foil.

In addition to one or more of the features described herein the tab cutting mechanism comprises a laser.

In addition to one or more of the features described herein the web roller includes a cylinder having a first end and a second end that defines a web roller axis, the surface being defined between the first end and the second end.

In addition to one or more of the features described herein the guide element support member is arranged at the first end and is rotatable about the web roller axis.

In addition to one or more of the features described herein the plurality of guide elements include a first guide element having a first dimension defined along the web roller axis, a second guide element having a second dimension defined along the web roller axis that is greater than the first dimension, and a third guide element having a third dimension defined along the web roller axis that is greater than the second dimension.

In addition to one or more of the features described herein each of the plurality of guide elements is circumferentially spaced from others of the plurality of guide elements along the guide element support member.

In addition to one or more of the features described herein an amount of battery foil passing over the web roller, the tab cutting mechanism forming a plurality of tabs in the battery foil.

A method of forming tabs in battery cell foil, in accordance with a non-limiting example, includes passing the battery cell foil over a web roller having a web roller axis, supporting a portion of the battery cell foil on a guide element support member including a plurality of guide elements, directing a tab cutting mechanism at a first one of the plurality of guide elements, cutting a first tab in the portion of the battery cell foil, the first tab having a first dimension corresponding to the first one of the plurality of guide elements, shifting the guide element support member while the battery cell foil is passing over the web roller to align a second one of the plurality of guide elements with the tab cutting mechanism, and cutting a second tab in the portion of the battery cell foil, the second tab having a second dimension, distinct from the first dimension, corresponding to the second one of the plurality of guide elements.

In addition to one or more of the features described herein directing the tab cutting mechanism includes aiming a laser at the first one of the plurality of guide elements.

In addition to one or more of the features described herein cutting the tab includes passing the laser through the battery cell foil into the first one of the plurality of guide elements.

In addition to one or more of the features described herein passing the laser through the battery cell foil includes guiding the laser to follow a pattern embodied by the first one of the plurality of guide elements.

In addition to one or more of the features described herein, the method further includes further shifting the guide element support member while the battery cell foil is passing over the web roller to align a third one of the plurality of guide elements with the tab cutting mechanism.

In addition to one or more of the features described herein cutting a third tab in the portion of the battery cell foil, the third tab having a third dimension, distinct from the first dimension and the second dimension, corresponding to the third one of the plurality of guide elements.

In addition to one or more of the features described herein shifting the guide element support member includes rotating the guide element support member relative to the web roller.

In addition to one or more of the features described herein cutting the first tab having the first dimension includes forming the first tab having a first length defined along the web roller axis of the web roller.

In addition to one or more of the features described herein cutting the second tab having a the second dimension includes forming the second tab having a second length defined along the web roller axis of the web roller.

In addition to one or more of the features described herein forming the second tab having the second length includes forming the second tab shorter than the first tab.

In addition to one or more of the features described herein, a battery cells is formed by the described method.

In addition to one or more of the features described herein directing the tab cutting mechanism at the first one of the plurality of guide elements includes activating a laser.

In addition to one or more of the features described herein activating the laser includes passing the laser through the battery cell foil and tracing a pattern defined by the first one of the plurality of guide elements to form the first tab.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic view of a web roller and shiftable guide element portion of a tab cutting system, in accordance with a non-limiting example;

FIG. 2 is a schematic view of a tab cutting mechanism directed toward a film passing over the web roller and shiftable guide element of FIG. 1, in accordance with a non-limiting example;

FIG. 3 is a plan view of a film having tab dimensions changed on the fly by the tab cutting system, in accordance with a non-limiting example; and

FIG. 4 is a is a plan view of two battery cells formed by the tab cutting system, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

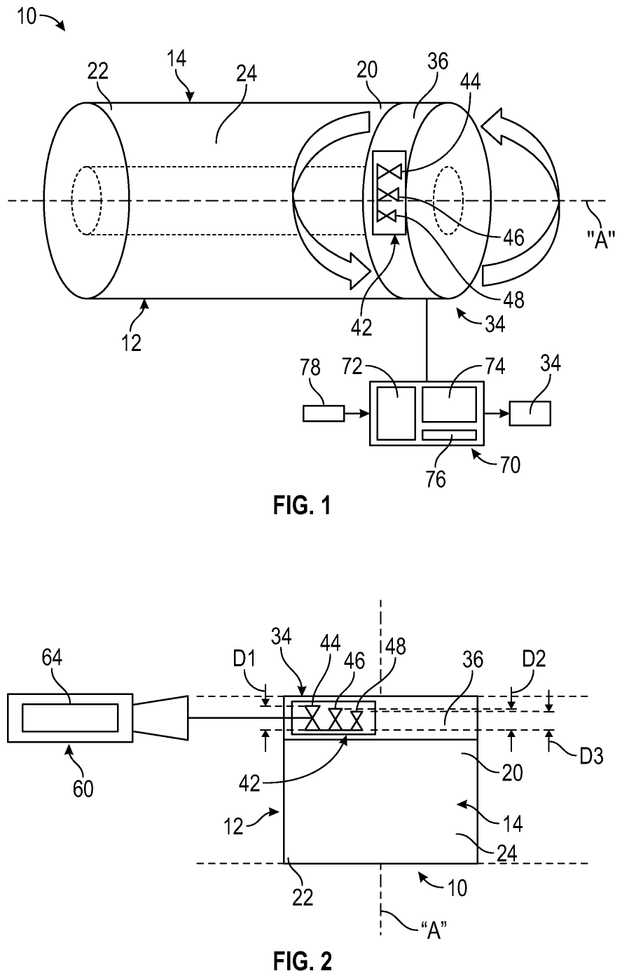

A system for forming tabs in a battery cell foil in accordance with a non-limiting example is shown at 10 in FIGS. 1 and 2. Tab forming system 10 includes a web roller 12 shown in the form of a cylinder 14. At this point, it should be understood that web roller 12 may take on a variety of forms. Web roller 12 includes a first end 20, a second end 22, and an outer surface 24 extending between first end 20 and second end 22. Web roller 12 includes a web roller axis “A” that extends between first end 20 and second end 22.

In a non-limiting example, a guide element support member 34 having a guide element support surface 36 is shiftably mounted at first end 20 of web roller 12. In a non-limiting example, guide element support member 34 may be selectively rotated about web roller axis “A” relative to cylinder 14 as will be detailed herein. A plurality of guide elements 42 are arranged on guide element support surface 36. In the non-limiting example shown, plurality of guide elements 42 include a first guide element 44, a second guide element 46, and a third guide element 48 circumferentially spaced from one another on guide element support surface 36. It should be evident that the number of guide elements may vary.

In a non-limiting example, first guide element 44 includes a first dimension “D1” measured along web roller axis “A”. Second guide element 46 includes a second dimension “D2” measured along web roller axis “A”. Third guide element 48 includes a third dimension “D3” measured along web roller axis “A”. In a non-limiting example, D1 is greater than D2 and D3, and D2 is greater than D3. At this point it should be understood that the particular order and relative positions of first guide element 44, second guide element 46, and third guide element 48 may vary. As will be detailed herein, each of the first guide element 44, the second guide element 46, and the third guide element 48 are associated with forming a foil tab of a selected length.

In a non-limiting example, a tab cutting mechanism 60 is arranged outwardly of web roller 12 as shown in FIG. 2. Tab cutting mechanism 60 includes a fixedly mounted laser 64 which is directed towards guide support surface 36. In a non-limiting example, guide support member 34 is selectively positioned so as to align one of the plurality of guide elements 42 with laser 64. As will be detailed more fully herein, guide support member 34 is selectively rotated about web roller axis “A” to position one of the first guide element 44, the second guide element 46, and the third guide element 48 into alignment with laser 64. As will also be detailed more fully herein, guide support member 34 may rotate without interrupting tab cutting operations.

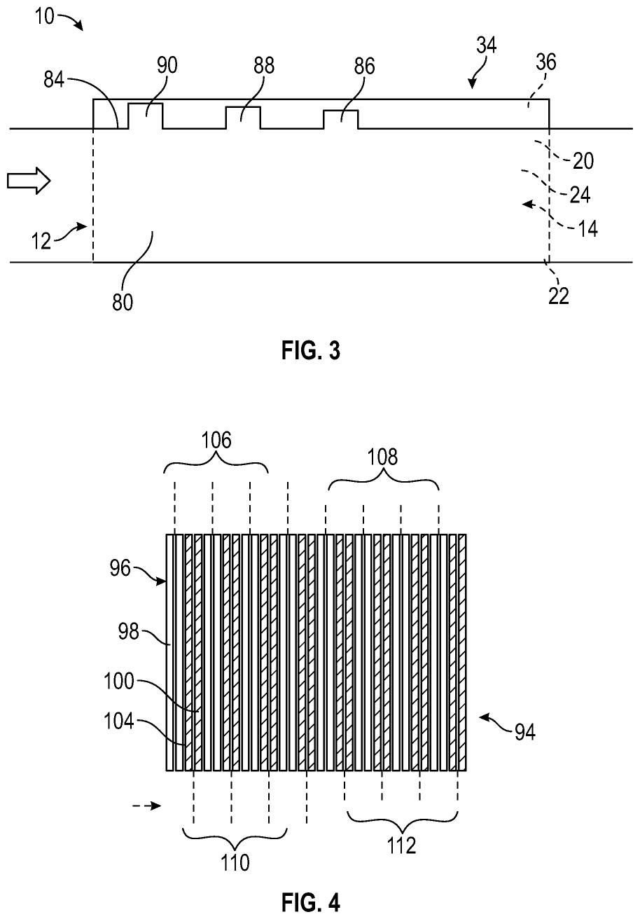

In a non-limiting example, a control system 70, FIG. 1, is operatively connected to guide support member 34. Control system 70 may be directly wired to guide support member 34 or connected through one or more wireless communication protocols. Control system 70 includes a central processor unit (CPU) 72, a guide element control module 74, and a memory 76. Control system 70 receives information, that may be in the form of programming, through an input 78 and controls a position of guide element support member 34 relative to web roller 12 in order to form tabs in a continuous sheet of battery cell foil 80 as shown in FIG. 3.

In a non-limiting example, a continuous sheet of battery cell foil 80 traverses outer surface 24 of web roller 12. An outer edge portion 84 of battery cell foil 80 passes over guide element support surface 36 of guide element support member 34. One of the plurality of guide elements 42 is aligned with laser 64. In a non-limiting example, third guide element 48 may be centered below laser 64. Laser 64 may be activated and controlled to trace a pattern defined by third guide element 48. Laser 64 passes through battery cell foil 80 into third guide element 48 to form a first tab 86 having a dimension D3. The number of first tabs 86 produced may vary.

After producing a selected number of first tabs 86, control system 70 shifts guide element support member 34 to align second guide element 46 with laser 64. Second guide element 46 is aligned with laser 64 without stopping movement of battery cell foil 80 over outer surface 24 of web roller 12. Thus, without interrupting work flow, a second plurality of tabs 88 are formed in outer edge portion 84 of battery cell foil 80. In a non-limiting example, once second guide element 46 is in position, laser 64 may be activated and controlled to trace a pattern defined by second guide element 46. Laser 64 passes through battery cell foil 80 into second guide element 46 to form a second tab 88 having a dimension D2. The number of second tabs 88 produced may vary.

After producing a selected number of second tabs 88, control system 70 shifts guide element support member 34 to align first guide element 44 with laser 64. First guide element 44 is aligned with laser 64 without stopping movement of battery cell foil 80 over outer surface 24 of web roller 12. Thus, without interrupting work flow, a third plurality of tabs 90 are formed in outer edge portion 84 of battery cell foil 80. In a non-limiting example, once first guide element 44 is in position, laser 64 may be activated and controlled to trace a pattern defined by first guide element 44. Laser 64 passes through battery cell foil 80 into first guide element 44 to form a third tab 90 having a dimension D1. The number of third tabs 90 produced may vary.

In a non-limiting example, battery cell foil 80 may be separated into individual sheets to form a battery cell 94 such as shown in FIG. 4. Battery cell 94 includes a plurality of foil sheets 96 that define cathodes, such as shown at 98 and anodes, such as shown at 100. Each cathode, anode pair is separated by a separator sheet 104. A first portion 106 of cathodes 98 may include a plurality of tabs having a first length and a second portion 108 of cathodes 98 may include tabs having a second length. Similarly, a first portion 110 of anodes 100 may include a plurality of tabs having a first length and a second portion 112 of anodes 100 may include tabs having a second length. By varying the length of the tabs, welded connections may overlap more easily so as to produced more robust and reliable welded connections.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for forming tabs in a battery cell foil comprising:
a web roller including a surface;
a guide element support member shiftably connected to the web roller, the guide element support member including a guide element support surface that is substantially co-planer with the surface of the web roller;
a plurality of guide elements supported on the guide element support member, each of the plurality of guide elements being associated with a different tab dimension, the plurality of guide elements being selectively shiftable relative to the surface of the web roller;
a tab cutting mechanism directed at one of the plurality of guide elements; and
a control system operatively connected to the guide element support member, the control system being operable to selectively shift select ones of the plurality of guide elements into alignment with the tab cutting mechanism in order to selectively control dimensional attributes of tabs being formed in a moving sheet of battery cell foil.

2. The system according to claim 1, wherein the tab cutting mechanism comprises a laser.

3. The system according to claim 1, wherein the web roller includes a cylinder having a first end and a second end that defines a web roller axis, the surface being defined between the first end and the second end.

4. The system according to claim 3, wherein the guide element support member is arranged at the first end and is rotatable about the web roller axis.

5. The system according to claim 4, wherein the plurality of guide elements include a first guide element having a first dimension defined along the web roller axis, a second guide element having a second dimension defined along the web roller axis that is greater than the first dimension, and a third guide element having a third dimension defined along the web roller axis that is greater than the second dimension.

6. The system according to claim 1, wherein each of the plurality of guide elements is circumferentially spaced from others of the plurality of guide elements along the guide element support member.

7. The system according to claim 1, further comprising an amount of battery foil passing over the web roller, the tab cutting mechanism forming a plurality of tabs in the battery foil.

8. A method of forming tabs in a battery cell foil comprising:
passing the battery cell foil over a web roller having a web roller axis;
supporting a portion of the battery cell foil on a guide element support member including a plurality of guide elements;
directing a tab cutting mechanism at a first one of the plurality of guide elements;
cutting a first tab in the portion of the battery cell foil, the first tab having a first dimension corresponding to the first one of the plurality of guide elements;
shifting the guide element support member while the battery cell foil is passing over the web roller to align a second one of the plurality of guide elements with the tab cutting mechanism; and
cutting a second tab in the portion of the battery cell foil, the second tab having a second dimension, distinct from the first dimension, corresponding to the second one of the plurality of guide elements.

9. The method of claim 8, wherein directing the tab cutting mechanism includes aiming a laser at the first one of the plurality of guide elements.

10. The method of claim 9, wherein cutting the tab includes passing the laser through the battery cell foil into the first one of the plurality of guide elements.

11. The method of claim 10, wherein passing the laser through the battery cell foil includes guiding the laser to follow a pattern embodied by the first one of the plurality of guide elements.

12. The method of claim 8, further comprising further shifting the guide element support member while the battery cell foil is passing over the web roller to align a third one of the plurality of guide elements with the tab cutting mechanism.

13. The method of claim 12, further comprising cutting a third tab in the portion of the battery cell foil, the third tab having a third dimension, distinct from the first dimension and the second dimension, corresponding to the third one of the plurality of guide elements.

14. The method of claim 8, wherein shifting the guide element support member includes rotating the guide element support member relative to the web roller.

15. The method of claim 8, wherein cutting the first tab having the first dimension includes forming the first tab having a first length defined along the web roller axis of the web roller.

16. The method of claim 15, wherein cutting the second tab having a the second dimension includes forming the second tab having a second length defined along the web roller axis of the web roller.

17. The method of claim 16, wherein forming the second tab having the second length includes forming the second tab shorter than the first tab.

18. A battery cell formed by a method comprising:
passing a battery cell foil over a web roller having a web roller axis;
supporting a portion of the battery cell foil on a guide element support member including a plurality of guide elements;
directing a tab cutting mechanism at a first one of the plurality of guide elements;
cutting a first tab in the portion of the battery cell foil, the first tab having a first dimension corresponding to the first one of the plurality of guide elements;
shifting the guide element support member while the battery cell foil is passing over the web roller to align a second one of the plurality of guide elements with the tab cutting mechanism;
cutting a second tab in the portion of the battery cell foil, the second tab having a second dimension, distinct from the first dimension, corresponding to the second one of the plurality of guide elements; and
stacking the first portion of the battery cell foil and the second portion of the battery cell foil to form a battery cell.

19. The battery cell according to claim 18, wherein directing the tab cutting mechanism at the first one of the plurality of guide elements includes activating a laser.

20. The battery cell according to claim 19, wherein activating the laser includes passing the laser through the battery cell foil and tracing a pattern defined by the first one of the plurality of guide elements to form the first tab.
